(19) United States
(12) Patent Application Publication
(10) Pub. No.: US 2010/0265311 A1
(43) Pub. Date: Oct. 21, 2010

(54) APPARATUS, SYSTEMS, AND METHODS FOR A SMART FIXTURE

(75) Inventors: Robert Carpenter, JR., Frisco, TX (US); Thomas C. Feuerborn, Flower Mound, TX (US); Thomas N. Nealon, Dallas, TX (US); Rich Thompson, Dallas, TX (US); Brent McClintock, Bedford, TX (US); Jeff Wade, Dallas, TX (US)

Correspondence Address: HAYNES AND BOONE, LLP;IP Section, 2323 Victory Avenue, Suite 700, Dallas, TX, 75219, US

(73) Assignee: J. C. Penney Corporation, Inc., Plano, TX (US)

(21) Appl. No.: 12/761,068

(22) Filed: Apr. 15, 2010

Related U.S. Application Data
(60) Provisional application No. 61/170,000, filed on Apr. 16, 2009.

(51) Int. Cl. H04N 7/14; H04N 5/225; G09G 5/00; G06F 3/041; G06Q 30/00; G06Q 10/00

(52) U.S. Cl. 348/14.08; 348/207.1; 345/633; 345/173; 705/14.65; 705/21; 705/22; 348/E07.077; 348/E05.024

(57) ABSTRACT

A device having a monitor operable to display information to a customer. The device further including a touch sensitive module coupled to the monitor. Also, the device has an image capturing module operable to capture an image of the customer. Additionally, the device has a storage unit operable to store the image of the customer and product information including information related to products offered at a retail establishment and products offered in an online store of the retail establishment. Furthermore, the device has a communication module communicatively coupling the device to a server via a network. The server accessing a database to provide up-to-date product information to the device.

### RELATED APPLICATIONS

This application claims the benefit of U.S. Provisional Application No. 61/170,000 Filed Apr. 16, 2009 entitled “Smart Fixture,” the disclosure of which is incorporated herein by reference in its entirety. Additionally, this application is related to co-pending U.S. patent application Ser. No. ______, filed Apr. 15, 2010, Attorney Docket No. 40612.18, entitled “Smart Fixture,” the disclosure of which is incorporated herein by reference in its entirety.

### BACKGROUND

Typically, a customer shopping in a retail establishment (e.g. brick and mortar store) is looking for a particular product to satisfy a need of the customer. The customer may peruse the retailer's in-store inventory (e.g. what the customer actually sees for sale within the store) in hopes of finding a particular product that meets their needs. The retailer may be limited to offering only certain styles and/or sizes of various products because of space limitations. Thus, the customer is limited to viewing and purchasing products that are only available at the retail establishment. However, the retailer may have access to additional products and/or styles that may not be offered for sale at the retail establishment.

Furthermore, retail establishments are frequently looking for ways to maximize the quantity of products for sale per square foot. In other words, retailers want to maximize the quantity of products available for purchase within a store while minimizing the floor space required for displaying the products.

Additionally, retail establishments are trying to improve customer service. In that regard, retail establishments strive to provide the best customer service to patrons of their business. However, shoppers visiting a retail establishment may, for example, become frustrated with waiting in line to purchase a product and/or lack of employees available to help answer questions regarding a product.

The subject matter of the present disclosure overcomes one or more of the shortcomings of the prior art.

### SUMMARY

A system comprising a device. The device having a monitor operable to display information to a customer. Additionally, the device has a touch sensitive module coupled to the monitor. Also, the device has an image capturing module operable to capture an image of the customer. Furthermore, the device has a local storage unit operable to store product information including information related to products in stock at a single location of a retail establishment, products in stock at other locations of the retail establishment, and products offered in an online store of the retail establishment. In addition, the device has an audio output operable to broadcast audio information including product information stored in the storage unit. Also, the device has a reader operable to identify a product that is handled by the customer. The reader including at least one of a barcode scanner, an RFID scanner, a magnetic card reader, and a smart card reader. Moreover, the device has a processing unit and a communications module communicatively coupling the device to a network. The processing unit running software that provides interactivity between the customer and the product information in the storage unit. Additionally, the device has a printing device operable to print product information. The system also includes a server communicatively coupled to a database. The database storing product information. The server further communicatively coupled to the device via the network for sending up-to-date product information to the local storage unit of the device.

A device having a monitor operable to display information to a customer. The device further including a touch sensitive module coupled to the monitor. Also, the device has an image capturing module operable to capture an image of the customer. Additionally, the device has a storage unit operable to store the image of the customer and product information including information related to products offered at a retail establishment and products offered in an online store of the retail establishment. Furthermore, the device has a communication module communicatively coupling the device to a server via a network. The server accessing a database to provide up-to-date product information to the device.

A method including providing a device at the retailer's store. The device having a monitor operable to display information to a customer. The device further including a touch sensitive module coupled to the monitor. Also, the device has an image capturing module operable to capture an image of the customer. Additionally, the device has a reader operable to identify a product that is handled by the customer. Furthermore, the device has a storage unit operable to store the image of the customer and product information. The product information including information about products offered for sale in-store and online by a retailer. In addition, the device has a communication module communicatively coupling the device to a network. The method further including receiving updated data that includes changes to the product information and an attract loop. The attract loop representing audio and visual data related to the product information. Additionally, the method includes displaying the attract loop as an initial sequence displayed on the device. The attract loop being set by accessing the reader. Moreover, the method includes detecting a triggering event at the device that ceases the attract loop and allows the customer to navigate the device. Also, the method includes sending the captured image of the customer to a remote device connected to the network. In addition, the method includes communicating with a user of the remote device by accessing the captured image of the customer.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a system diagram according to an embodiment of the present invention.

FIG. 2 is a block diagram of an embodiment of the smart fixture device of the system shown in FIG. 1.

FIG. 3 is a flowchart depicting an exemplary operating method of the smart fixture device shown in FIG. 2.

FIG. 4 is a flowchart depicting the browsing and search capabilities of the smart fixture device shown in FIG. 2.

FIG. 5 is a flowchart depicting the point of sale functionality of the smart fixture device shown in FIG. 2.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

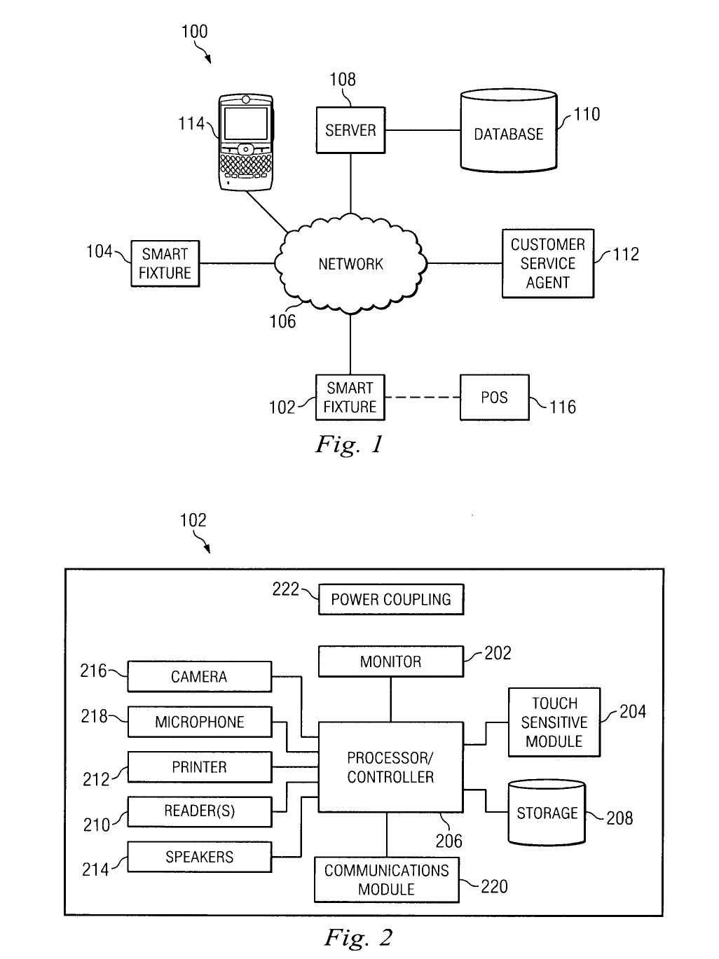

FIG. 1 shows a system 100 according to an embodiment of the present invention. For example, system 100 may include smart fixtures 102 and 104 coupled to one another via a network 106. The smart fixtures 102 and 104 are further in communication with a server 108 and database 110. Additionally, smart fixtures 102 and 104 are in communication with a customer service agent 112, a remote device 114, and a point of sale device 116. System 100 is directed to providing an improved shopping experience for customers visiting a retail establishment.

Due to size limitations, not every retail store carries a wide selection of products in any given area. However, with a retailer's nationwide distribution capabilities, any online merchandise can be easily shipped to retail customers directly and to the retail store location at which customers shop. System 100 enables an in-store customer access to a retailer's diverse assortment of products that are carried in-store and online.

In that regard, smart fixtures 102 and 104 are devices that allow in-store customers convenient and easy access to a retailer's diverse assortment of products that are carried in-store and online. Specifically, smart fixtures 102 and 104 showcase the breadth of the in-store and online product assortment to the customer accessing the fixture. For example, if the retailer carries a certain product in a retail establishment location, there may be a limited number of product colors available at the particular retail establishment location. In particular, different store locations for a particular retailer may only carry the product in white and black. However, that same retailer may offer the same product on their online store and/or in another store, but in other colors. By exposing the customer to the retailer's system-wide inventory (e.g. products that are available in any store and/or online) the retailer can help the customer find the exact product, in the exact style (e.g. color) that they desire.

Smart fixtures 102 and 104 may be substantially similar. For ease of discussion purposes only smart fixture 102 will be described herein. However, any component and/or function discussed herein with respect to fixture 102 is applicable for smart fixture 104.

Moreover, smart fixture 102 will be described herein as if the fixture is physically located within the retail store. However, it is contemplated that smart fixture 102 can be located anywhere including outside of the retail store. In other words, smart fixture 102 can be considered as a satellite storefront. In that regard, smart fixture 102 represents a retail establishment even if the fixture is not physically located within the retail store that it represents. For example, smart fixture 102 can be located in high traffic areas such as shopping malls, grocery stores, gas stations, movie theaters, theme parks, airports, bus/train stations, and sporting events.

As shown in FIG. 1, smart fixture 102 is coupled to network 106. Network 106 can be a wide-area network, local area network, and/or the Internet. Accordingly, network 106 can be considered as any type of computer network known to one skilled in the art for connecting various devices.

Coupled to network 106 is server 108 that provides the back-end network functionality for a retailer's physical store and online store. Server 108 may be a single server or more than one server that deliver services or information to other devices such as smart fixture 102. For example, server 108 may be a web server that transmits web content containing product information in response to requests from smart fixture 102. Moreover, server 108 may have video conferencing (e.g. telepresence) hosting capabilities that enable a device, such as smart fixture 102 to conduct a video conference with another device connected to network 106. Furthermore, server 108 may provide updates, for example, to smart fixture 102 relating to the functionality of the fixture such as the software and product inventory data.

Database 110 is coupled to server 108 and can be accessed by the server to transmit stored data to smart fixture 102. Database 110 may store any information relating to products and services offered by the retailer. For example, database 110 may receive and store data relating to inventory for a particular store and/or for inventory across all stores (e.g. system wide inventory for a retailer). Such inventory data may include, but not limited to product description, product availability, and product pricing information. Furthermore, database 110 may store competitor information such as pricing for the same and/or similar product being offered by a retailer for comparison purposes.

Moreover, database 110 may store data relating to customer data. For example, customer data may include account information, loyalty/reward program information, and/or historical purchasing information made by the customer. Also, database 110 may store data relating to marketing and promotional materials related to products being offered in-store and/or online. Additionally, database 110 may store data relating to the layout of a retailers store and where within the layout a particular product is located.

Additionally, database 110 can store statistical data received from smart fixture 102 via network 106. Such statistical data can include, but not limited to usage statistics related to product page views (e.g., number of pages viewed, amount of time each page viewed, etc.), purchase history (e.g., what has been purchased at the kiosk), and/or current configuration of the fixture that attracted a shopper to the fixture (e.g., what was being displayed by the smart fixture when the customer interacted with the fixture).

Customer service agent 112 shown in FIG. 1 is available to assist a customer using smart fixture 102. Even though customer service agent 112 is shown as a single presence connected to network 106, it is contemplated that customer service agent 112 may be representative of more than one agent located at the same or different locations. For example, customer service agent 112 may be representative of individuals at a call center that is located remotely from smart fixture 102. Furthermore, customer service agent 112 may represent individuals located at the retailer's store. For example, customer service agent 112 may be employees accessible to the customer in-store via smart fixture 102. Moreover, customer service agent 112 may represent virtual or automated agents such as computer systems and software (e.g. interactive voice response systems) that are capable of providing automated assistance to a customer.

A customer may access a customer service agent 112 through smart fixture 102 by using the fixture to communicate via any know means including, but not limited to audio, video, email, chatting, and/or texting. For example, a customer using smart fixture 102 can utilize the fixture to initiate a video conference session to customer service agent 112 in order to obtain assistance with inquiries related to, for example, products, use of the smart fixture, ordering, and/or account information. Additional details relating to a customer obtaining assistance from customer service agent 112 will be described below.

Remote Device 114 may be one or more devices capable of connecting to network 106 in order to communicate with smart fixture 102 and/or each other. For example, remote device 114 may be a mobile phone, notebook computer, netbook computer, desktop computer, tablet computing device, smartphone, personal digital assistant, and/or e-book reader. Smart fixture 102 may supply remote device 114 any information that may be accessible to the fixture. In that regard, remote device 114 may communicate via any known means including, but not limited to audio, video, email, chatting, and/or texting with smart fixture 102. Moreover, such communication may be initiated by either the smart fixture 102 or the remote device 112. As will be described in further details below, the interaction between smart fixture 102 and remote device 112 may enable a social networking connection that enables the customer using fixture 102 to share their experience with a user of the remote device 114.

Furthermore, FIG. 1 shows a point of sale device 116 that may be optionally coupled to smart fixture 102. Point of sale device 116 may, for example, be a store checkout device (e.g. cash register) or similar device that is separate from smart fixture 102. For example, point of sale device 116 may enable a customer to purchase a product that the customer viewed on the smart fixture device 102.

FIG. 2 is a block diagram of smart fixture 102 of system 100 shown in FIG. 1. As discussed above, smart fixture 102 is a touch screen device that is designed to allow in-store customers easy access to a retailer's diverse assortment of products that it carries in-store and/or online. For example, J.C. Penney Corporation, Inc. (J.C. Penney) has physical retail stores (e.g. brick and mortar stores) as well as an online store at www.jcp.com. Due to size limitations, not every retail store carries a wide selection of products in any given area. However, with a retailer's nationwide distribution capabilities, any online merchandise can be easily shipped to retail customers directly and to a retailer's physical store.

Referring to FIG. 2, smart fixture 102 includes a monitor 202 and a touch-sensitive module 204. Monitor 202 may be a touch screen monitor capable of displaying high resolution images that depict products for sale in-store and/or online. The monitor 202 may, for example, in one embodiment be a 42 inch touch screen monitor. However, it is contemplated that monitor 202 may be any screen size.

Controller 206 couples monitor 202 to touch sensitive module 204. Touch sensitive module 204 receives and processes the detection of a customer touching monitor 202. In that regard, the touch sensitive module 204 enables a customer to interact with smart fixture 102 by touching the screen. For example, a customer can use one-touch, two-touch, and/or drag gestures to navigate through the various screens and images displayed on monitor 202. Moreover, a customer can zoom in or zoom out on any portion of the image being displayed on monitor 202.

Smart fixture 102 may include FLASH based application software. Controller 206 may, for example, execute a FLASH based application that enables customer access to all of the products available from a retailer's store and/or online website. To insure optimum response time for customers, the application content may be cached or stored in the smart fixture's local storage device 208. Such caching improves the customer's experience because the smart fixture avoids having to rely on external sources such to provide requested information to the customer.

For example, storage 208 may be one or more memory devices that may include, but not limited to a hard drive, flash memory, and/or solid state memory. Storage 208 may store any information relating to products and services offered for viewing and sale by smart fixture 102 described above. For example, storage 208 may store data relating to inventory for a particular store and/or for inventory across all stores (e.g. system wide inventory for all stores). Such inventory data may include, but not limited to product description, product availability online and/or in-store, and/or product pricing in-store and/or online. Furthermore, storage 208 may store competitor information such as pricing for the same and/or similar product being offered by a retailer for comparison purposes.

Smart fixture 102 may capture and store customer-related data in storage 208. For example, smart fixture 102 monitors the selections that each customer of the smart fixture makes when utilizing the smart fixture. In this regard, the retailer can capture valuable information. For example, data pertaining to the customer's viewing, product selection, style selection, and other usage data may be captured and stored by smart fixture 102. Moreover, if a customer provides some identifying information to the smart fixture 102 (e.g. email address) when viewing a product on the fixture, but did not make the purchase, the retailer may use the customer's identifying information to contact the customer with additional information and/or additional incentives for the customer to make a purchase.

In addition, smart fixture 102 can determine or gauge product preferences by tracking the products viewed by customers. In some instances, a timestamp may be captured by smart fixture 102, so that retailers can determine how long customers spent viewing a product. Moreover, smart fixture 102 may capture the conversion rate at which customers purchase products that they view on the fixture. These statistical data may be stored in storage 208.

Additional customer-related data may include, for example, account information, loyalty/reward program information, and/or historical purchasing information made by the customer. Also, storage 208 may store data relating to marketing and promotional materials related to products being offered in-store and/or online. Additionally, storage 208 may store data relating to the layout of a retailers store and where within the layout a particular product is located.

It should be noted that any data stored in storage 208 can be transmitted and/or shared with any authorized device coupled to network 106. For example, smart fixture 102 can transmit and/or share data with server 108. Server 108 can subsequently store such data in database 110. Furthermore, it is contemplated that any data stored by database 110 may be transmitted and/or shared with any authorized device such as smart fixture 102. Accordingly, such data transmitted and/or shared by database 110 with smart fixture 102 may stored in storage 208.

As shown in FIG. 2, smart fixture 102 may have one or more readers 210. For example, readers 210 may include one or more of the following, such as a barcode scanner, RFID reader, magnetic-strip card reader, and/or smart card reader. In some embodiments, for example, scanned barcode data is interpreted and used to display product information. In alternative embodiments, the barcode scanner is replaced with an RFID scanner that performs a comparable function. In yet other embodiments, the smart fixture includes both barcode and RFID scanners.

Moreover, a magnetic-strip card reader may, for example, provide the option for customers to swipe their credit cards while standing at the fixture, allowing them to “checkout” through some screens displayed on monitor 202. In alternative embodiments, the magnetic-strip card reader is replaced with a smart card reader that performs a comparable function. In yet other embodiments, the smart fixture 102 includes both magnetic-strip card and smart card readers.

Additionally, smart fixture 102 may have a printer 212 enabling a customer to print information. In that regard, printer 212 may enable a customer to print information relating to any product and/or service associated with smart fixture 102. For example, and not by way of limitation, a customer maybe able to print purchase receipts, store maps and directions, wish lists, bridal registry, baby registry, and/or product details.

As shown in FIG. 2, smart fixture 102 may include an imaging capturing module including a camera 216. Camera 216 may enable the fixture to provide an augmented reality for a customer. For example, camera 216 may capture a customer's image such that controller 206 can access storage 208 and merge the customer's image with a particular product and/or products. This merged image may be displayed on monitor 202. In other words, camera 216 may enable a customer to view their image with any product available in-store and/or online without having to physically access the actual product. A customer may then virtually “try-on” an outfit and accompanying accessories, for example.

Moreover, camera 216 detect the presence of a customer or enable recognition of a customer. For example, camera 216 may capture facial features of the customer and store these features in storage 102. A comparison of stored facial features to captured facial features may enable the smart fixture to determine whether the customer has previously used the smart fixture device. Upon recognition of a customer, smart fixture 102 may deliver personalized information to the customer. For example, smart fixture 102 may display on monitor 102 a personalized greeting to the customer. In fact, if the customer's name has been previously associated with the stored facial features the fixture may even be able to greet the customer audibly by name via speakers 214. Moreover, smart fixture 102 may change what is being displayed on monitor 202 based on the previous purchase history or other information of a customer that has been recognized by smart fixture 102.

Furthermore, camera 216 in combination with microphone 218 and speakers 214 may enable a customer to communicate with, referencing FIG. 1, customer service agent 112, remote device 114, and/or another smart fixture such as smart fixture 104. In that regard, smart fixture 102 has a communication module 220 that enables the fixture to couple to network 106. Communication module 220 may include any type of interface necessary to effectively communicate via network 106. Moreover, the communication module's connection to network 106 may be wired and/or wireless. Thus, a customer utilizing smart fixture 102 may communicate via any known means including, but not limited to audio, video, email, chatting, and/or texting to any device connected to network 106.

Smart fixture 102 may act as a hotspot such that customers may connect their own mobile device (e.g. smartphone, PDA, netbook computer, notebook computer, etc.) to network 106 via smart fixture 102. Such a hotspot, for example, may enable customers to access the Internet via smart fixture 102. Moreover, smart fixture 102 may have browsing capabilities such that a customer can use the fixture's monitor to browse the internet, play internet based games, and/or send/receive email.

Referencing FIG. 2, smart fixture 102 may have a power coupling 222. Power coupling 222 can be any interface necessary for providing power to smart fixture 102. For example, power coupling 222 may be a power pole coupling. In that regard, a power pole coupling allows smart fixture 102 to be located anywhere in-store where a power pole may be accessible.

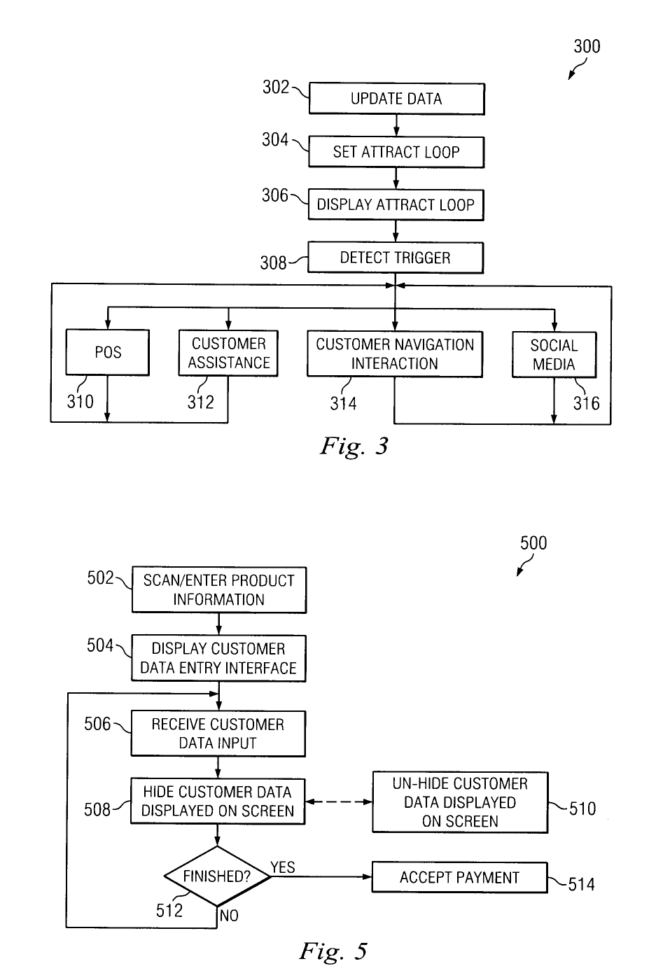

FIG. 3 is a flowchart depicting an exemplary operating method 300 of the smart fixture 102 shown in FIG. 2. Method 300 begins at block 302 where storage 208 of smart fixture 102 is updated. The update data may be delivered to the smart fixture device via the communication module's connection to network 106. For example, server 108 accessing database 110 may provide the update data to smart fixture 102 across network 106.

The update data may relate to any information about products and services. For example, the update data may be about the inventory for a particular store and/or for inventory across all stores (e.g. system-wide inventory for all stores). Such inventory data may include, but not limited to product description, product availability online and/or in-store, and pricing of a product. Furthermore, the update data may include competitor information such as pricing for the same and/or similar product being offered by a retailer for comparison purposes.

Moreover, the update data may relate to customer data. For example, customer data may include account information, loyalty/reward program information, and/or historical purchasing information made by the customer. Also, the update data may include information relating to marketing and promotional materials and offers related to products being offered in-store and/or online. Additionally, the update data may relate to the layout of a retailers store and where within the layout a particular product is located.

Additionally, the update data may include information relating to one or more attract loops capable of being displayed on monitor 202 of smart fixture 102. The attract loop represent various audio clips, video loops, and/or still images that are capable of being displayed on an initial screen of the smart fixture 102. The initial screen displayed by smart fixture 102 is designed to invite customers to interact with the smart fixture.

The transmittal of update data to smart fixture 102 during step 302 may occur at regular intervals and/or on the occurrence of a specified event. For example, update data may be transmitted every hour, once a day, and/or once a week. However, update data may be transmitted upon an inquiry from smart fixture 102 to server 108. Moreover, update data may be transmitted when an error occurs within smart fixture 102 and the fixture is unable to operate as described herein.

Moreover, the update data may only include changes that have occurred since the last update. For example, database 110 may compare the previous update data transmitted to smart fixture 102 to the current update data and determine the difference between the data sets. Subsequently, the update data transmitted to smart fixture 102 may include only changes (additions, deletions, or modifications) from the previous update data.

Upon completion of the update data, method 300 progresses to optionally set the attract loop at block 304, which causes the smart fixture to display a predetermined attract loop at block 306. The update data can be programmed to direct controller 106 to display a certain attract loop on monitor 202 of smart fixture 102. In other words, the update data may determine what attract loop to display on smart fixture 102.

However, in some embodiments setting the attract loop is accomplished by interacting with smart fixture 102. A code may be inputted into smart fixture 102 that corresponds to a particular attract loop stored in storage 108. Alternatively, a barcode may be scanned by the barcode reader of smart fixture 102 that corresponds to a stored attract loop. Similarly, an RFID tag, magnetic strip, and/or smart code may be read by one of the corresponding readers 210 that corresponds to a stored attract loop. Thus, smart fixture 102 may display the appropriate attract loop based on the received code.

After setting the attract loop, smart fixture 102 retrieves the attract loop from storage 108 and displays the attract loop. As discussed above, the attract loop may represent various audio clips, video loops, and/or still images that are designed to invite customers to interact with the smart fixture. The attract loop may run continuously until a triggering event occurs at block 306.

Given the location of smart fixture 102 within a store the attract loop may be set to correspond to products that are nearby within the store. Furthermore, the attract loop may be set to correspond to products available online that are similar and/or complement products near the fixture in the store. For example, if smart fixture 102 were positioned near the shoe department the attract loop may relate to shoes available in-store and/or online. However, in some embodiments the attract loop may not correspond necessarily to the products that are nearby in store. In such a scenario the attract loop may display products that the retailer may be trying to promote regardless of the location of the fixture within the store.

As discussed above, the attract loop may run continuously until a triggering event is sensed at block 308. For example, a triggering event may be a customer touching monitor 202. In other embodiments, the triggering event may be based on smart fixture 102 recognizing the presence of a customer based on sounds such as the customer's voice and or noise made by the customer as passing by the fixture. Moreover, the triggering event may be based on smart fixture 102 recognizing the presence of a customer based on an infrared reading (e.g. heat signature), facial recognition, and/or motion.

The triggering event may take the customer to a welcome page showing all available categories of products, a department page showing products that are categorized together, and/or to a page of products that relate to the attract loop. Moreover, smart fixture 102 may provide a customized home page for each customer when the fixture recognizes the customer. For example, as discussed above, smart fixture 102 may recognize the customer when the facial recognition captured by camera 216 matches the stored facial recognition pattern in storage 208.

Similarly, smart fixture 102 may recognize a customer based on some other identifying characteristic. For example, a customer may have a card provided by the retail store, such as a credit card that includes either an RFID signal and/or smart card. Smart fixture 102 may determine the customer by reading the RFID signal and/or smart card via readers 210.

The triggering event may indicate that the customer desires to proceed to point of sale 310, customer assistance 312, customer navigation interaction 314, or social media 316.

Point of sale 310 is a process that enables the customer to use the smart fixture as a self checkout register. In other words, point of sale 310 provides the ability for the customer to make a purchase of a product located either online or in-store. In fact, as described below in more detail, point of sale function 310 enables a customer who has found a product in-store to scan the product and pay for the product at the smart fixture 102.

Customer assistance 312 is a process to enable the customer to use smart fixture 302 to obtain assistance. For example, the customer may need assistance with respect to using the fixture and/or obtaining help with respect to the retailer's store, products, and/or services. In such a case, smart fixture 102 may have a touchable help button displayed on monitor 202. By touching the help button, the customer may access the assistance they require. For example, the customer may directly engage with customer service agent 112 via audio, video, chatting, and/or texting by pushing the help button.

In addition to answering the customer's questions via audio, video, chatting, and/or texting, the customer service agent 112 may push information to smart fixture 102. The pushed information may appear on the monitor 202 and/or as printed information from printer 212. For example, the pushed information may be recommended products and the location within the store of where the products are located.

Moreover, customer service agent 112 may provide consultation services to the customer. For example, smart fixture 102 may capture the customer's image that may be transmitted to the agent. The agent, for example, may be a cosmetic consultant that can use the image to recommend various cosmetic products to the customer. In some embodiments, the agent can manipulate the customer's image as it appears on monitor 202 such that the customer can observe what the recommended cosmetic products may look like on the customer.

It should be noted that the customer service agent acting as a cosmetic consultant is for exemplary purposes only. No limitation to is implied by way of this example. In fact, customer service agent 112 may advise client on any product and/or service for sale in-store or online. Moreover, the customer's image can be used by the smart fixture and/or customer service agent to superimpose and/or modify the customer's image in view of any product and/or service offered by the retailer in-store and/or online.

Moreover, the customer can receive in-store help by accessing help at block 312. For example, a customer may use the help feature on smart fixture 102 to request an in-store employee to meet the customer at the fixture to answer questions. Moreover, the customer may use smart fixture 102 to contact an in-store employee to bring the customer a specific product.

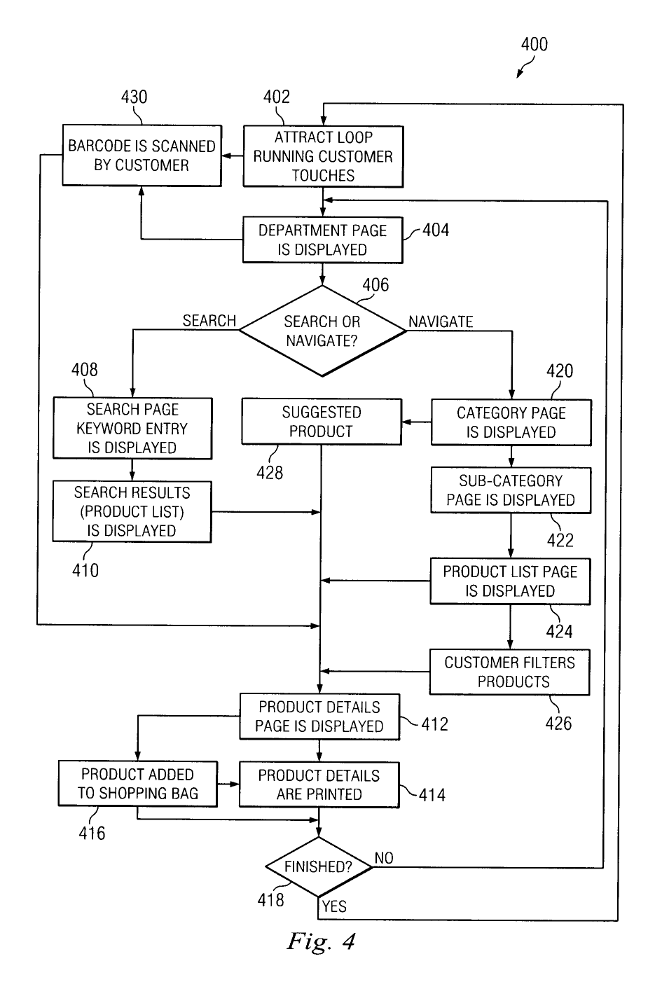

Customer navigation interaction 314 is a process that enables the customer to interact with the smart fixture device 102 for product/service information. In other words, customer navigation interaction 314 provides the ability for the customer to navigate through all products offered for sale by the retailer. Customer navigation interaction 314 will be described in more detail below with respect to FIG. 4.

Social media 316 is a process that enables the customer to use smart fixture 102 to communicate with friends and family. For example, as discussed above, smart fixture 102 can communicate with, customer service agent 112, remote device 114, and/or another smart fixture such as smart fixture 104. In that regard, the customer can communicate with friends and family using these devices via any known means including, but not limited to audio, video, email, chatting, and/or texting. For example, the customer can use any combination of microphone 218, camera 216, and speakers 214 of smart fixture 102. Moreover, the customer can access, for example, an on-screen qwerty style keyboard in order to chat, text, and/or email these other devices.

The social media aspect of smart fixture 102 enables the customer to socially share their shopping experience with others. For example, as discussed above, smart fixture 102 can enable an image of an outfit to be merged with a customer's image captured by camera 216. Smart fixture 102 then allows the customer to invite friends and family to join in viewing the customer's merged image on the product. In that way, the customer can receive feedback on how others may feel about the outfit. Alternatively, the customer may try-out the actual product in front of camera 216 such that friends and family may view the customer via videoconference.

Moreover, the customer may receive feedback from others about a particular product. For example, a customer using smart fixture 102 may send and receive product details to and from customer service agent 112, remote device 114, and/or another smart fixture 104. In that regard, the customer may receive feedback and/or recommendations with respect to particular products from friends and family. Furthermore, users of these other devices may merge suggested products onto the customer's image as it is being viewed on monitor 202 of smart fixture 102, thereby allowing the customer to see a recommendation on their own augmented-reality image.

Additionally, social media 316 may enable the customer to interact with smart fixture 302 to obtain reviews and/or ratings on various products and services. For example, reviews and/or ratings may be provided by the customer, other customers, the store, independent third-party reviewers, and/or the manufacture of the product. Reviews and/or ratings may, for example, be audio, video, and/or text based stored on the fixture and/or received from other sources. In that regard, the customer may use camera 216, microphone 218, and/or monitor 202 of smart fixture 102 to provide the reviews and/or ratings. Moreover, it is contemplated that reviews and/or rating are not limited to products, but may include rating and/or reviews of the store, personnel, and/or the previous reviewers themselves.

Furthermore, the customer has the ability to capture and save these social media data on smart fixture 102. For example, the customer can store the contents of social media interactions on the smart fixture's storage 108. Additionally, the customer may email the product related information, recommendations, comments, and/or augmented reality images discussed between the customer and the users of the other device. Furthermore, the customer may print product information, recommendations, comments, and/or augmented reality images discussed during their social media interaction with the users of the other devices. Moreover, the printout may include the exact location of the item within the store.

FIG. 4 is a flowchart depicting a method 400 for browsing and search capabilities of the smart fixture 102 shown in FIG. 2. Method 400 begins at block 402 when the customer triggers the browsing and search capabilities by interrupting the attract loop. Here, the customer interrupts the attract loop by touching monitor 202 of smart fixture 102. The triggering event causes the monitor, for example, to display a department page for the store at block 404. Department page 404 represents various products in-store and/or online that may be grouped together because they have similar functions and/or are typically purchased together. Exemplary departments for a store may include, but not limited to a home furnishing department, house wares department, bath and bedding department, men's clothing department, women's clothing department, children's clothing department, and jewelry department.

The department page may contain touchable images on monitor 202 that identify the various departments available to navigate through and/or include a search function. Decision block 406 represents the customer's choice of how to navigate or search a store's inventory of products. If the customer chooses to search for a product via the search function, the customer may be directed to a search page by choosing a touchable search function box on monitor 202 at block 408. The search page may be a box displayed on the same page of the department page or may be a completely new page that the customer may be directed to for searching purposes.

Moreover, it should be noted that a touchable search function box may be present on every page viewed by the customer such that at anytime while using smart fixture 102 the customer may use keywords to search for a product. Furthermore, it should be noted that at any point during the search process a touchable button may be present on the screen that enables the customer to return to decision block 406 where the customer can decide whether to search or navigate.

In block 408, the customer enters keywords relevant to a product. As previously discussed, storage 208 of smart fixture 102 stores information relating to all products offered by the retailer. The product information may include metadata about a product including common terms used to identify the product. In some instances, the search function takes advantage of metadata relating to two internal product-level fields that describe every product's item type and product type. Thus, by cross-referencing the keywords entered by the customer with the product information stored in storage 208, smart fixture 102 can display matching search results on monitor 202 at block 410.

Upon reviewing the search results, the customer may touch the search results to select the product most relevant to their needs. Upon selecting a particular product, the corresponding product details page is displayed at block 412. The product details page provides details relating to the product. For example, if the product were a shoe the details page may provide information describing the shoe. Moreover, the details page may provide additional information such as available sizes, colors, styles, availability, and/or pricing.

Furthermore, the product details page may show the pricing history of the product. For example, the page may show an original price and a discounted price. Furthermore, the product details page may show a competitor's price of the same or comparable product, so that the customer may comparison shop. Additionally, the product details page may show the price of the product for in-store purchase versus the online price.

The product details page enables the customer to view the product in more detail. For example, storage 108 may have several views of the product, including but not limited to front, sides, back, overhead, beneath, and/or 360° images. Smart fixture 102 enables a customer to alter the view of the product to any of the stored views. Moreover, the customer can zoom in and/or zoom out on any image of the product. Additionally, as discussed above, smart fixture 102 enables the customer to experience augmented-reality in which a particular product may be merged with a customer's image.

Furthermore at the product details page smart fixture 102 may enable the customer to generate a computer model of a body type. For example, the smart fixture may ask the customer to input height, weight, hair color, hair length, eye color, skin tone, and additional other characteristics. Subsequently, the customer can place products on the computer model similar to a virtual dress-up doll in order to observe how particular products look on a particular body type.

Additionally, the product details page may include the option for the customer to send an email or otherwise transmit any data related to the product. For example, the customer simply adds their email address into a designated area on the page, and then selects the email option. The product details page is then emailed to the customer. This email capability may be allowed with respect to any page viewed by the customer. In other words, any information that the customer views with respect to smart fixture 102 may be emailed by or sent to the customer.

Moreover, the product details page may allow the customer to see the stock levels for products within the store. Additionally, the product details page may allow the customer to see the stock levels for products within any stores they choose based upon input such as zip codes and/or city/state names. Furthermore, the product details page may allow the customer to see the stock levels for products in the online.

Additionally, the product details page may suggest other products that the customer may be interested in purchasing. The product details page may show matching items for the product. For example, if the customer is viewing a shirt then the smart fixture may recommend a jacket and pants that coordinate with the shirt. Similarly, the product details page may suggest alternative products that have similar features and/or styling with respect to the product the customer is viewing. Also, the product details page may suggest “don't forget” products because they are typically purchased together. Furthermore, the product details page may suggest products to the customer based on what other customers purchased when viewing the same and/or similar product details page. In addition, the product details page may suggest products to the customer based on what the customer previously purchased from the retailer.

From the product details page the customer may print the product details using smart fixture 102 at block 414. The information capable of being printed may include anything related to the product details page including, but not limited to information about the product including, but not limited to written descriptions, sizing, style options, pricing, availability, reviews, various product view, augmented reality information, and/or the computer model of the body type with the products associated with it.

Moreover, the printed product details may include a corresponding product identifier such as a barcode and/or an alphanumeric sequence. The printed product details can be taken to point of sale device 116, which may be for example, a checkout register within the retail store where a retail associate can use the barcode and/or alphanumeric sequence to pull up the products and find the products in-store for the customer and process a purchase. Additionally, if the product is available only online then the sale associate can place the customer's online order and have the product delivered to the store or the customer's place of choosing.

Additionally, should the customer decide, they can go home and use the retailer's online store to input the product identifier. By using a search box on the retailer's online store, the same product viewed on the smart fixture will be shown, and the customer may complete the order at that time.

Furthermore, because smart fixture 102 includes a store directory and store map the product details page may direct the customer from their location in the store to where different departments and/or where a particular product may be found within the store. In some instances, the printed product details received from smart fixture 102 may show a map of the store and the path that the customer can take to arrive at the location where the product of interest is located.

From the product details page, the customer may alternatively, or in addition to printing the product details, decide to add one or more products to their shopping bag at block 416. Once a product is in the customer's shopping bag, the customer can use smart fixture 102 as an automated checkout register. In other words, smart fixture 102 provides the ability for the customer to make a purchase of a product located either online or in-store once the product is in the customer's shopping bag. As discussed above, smart fixture 102 may include a magnetic-strip reader and/or smart card reader. In this regard, smart fixture 102 provides the option for customers to swipe their credit cards through the appropriate reader while standing at the fixture thereby allowing them to purchase their selected product.

Additionally, the customer can choose to electronically send their shopping bag to point of sale device 116, for example, a checkout register in the store. In that regard, smart fixture 102 may be communicatively coupled with the in-store checkout registers such that the fixture may send the contents of the customer's shopping bag to the checkout register. Upon arrival to the in-store checkout register the customer can supply some identifying information to the cashier in order to link the customer to the receive shopping bag contents at the checkout register. For example, the customer may provide the printed product details page having a barcode and/or alphanumeric sequence that corresponds to the customer's shopping bag. However, the received shopping bag contents at the checkout register may be linked to the customer by the customer having supplied identifying information (e.g. name, email address, telephone number, etc) to smart fixture 102. The identifying information may be sent electronically with the customer's shopping bag to the cash register. Thus, the customer can use the in-store checkout register without providing any printed product details page to the checkout register. Additional details regarding the point of sale functionality of smart fixture 102 will be described below in reference to FIG. 5.

After the customer has either added the product to their shopping bag at block 416 and/or printed product details at block 414, the smart fixture may inquire at decision block 418 whether the customer is finished utilizing the fixture. If the customer is not finished using smart fixture 102 then the fixture may return the customer to the department page at block 404, for example. However, if the customer is finished utilizing smart fixture 102 then the fixture returns to block 402 where the attract loop continuously runs until the next customer touches the monitor of smart fixture 102.

Returning to decision block 406 of FIG. 4, smart fixture 102 provides various ways that a customer can navigate through. If the customer chooses to navigate through a store's inventory of products then a category page within a particular department may be presented to the customer at block 420. For exemplary purposes only, assume here that at block 404 the customer chose to navigate through the men's clothing department. Then at the category page, for example, the customer may be presented with several categories of men's clothing that are selectable via the customer touching monitor 202. For example, categories of men's clothing may include, but not limited to men's business attire, men's casual attire, and men's athletic attire.

Upon selecting a particular category, the customer may be presented a sub-category page at block 422. Continuing the above example, assuming the customer selects men's business attire then the sub-categories presented to the customer may include, but not limited to men's dress shirts, men's dress ties, men's dress belts, and/or men's dress shoes. Similarly, the customer may navigate through these sub-categories by touching the monitor 202 of smart fixture 102.

Subsequent to selecting a sub-category the customer is then presented a product listing at block 424. Here, for example, if the customer selected the dress shoes subcategory from the example above then the customer would be presented a product listing of dress shoes. Upon reviewing the product listing, the customer may touch the product listing to select the most relevant product to meet their needs. Selecting a particular product directs the customer to the product details page which is displayed at block 412.

Alternatively, smart fixture 102 may provide the customer the ability to further filter and/or refine the product list displayed to the customer at block 426. For example, smart fixture 102 may allow customers to search for products based upon product attributes. For instance, continuing the above example, when further filtering the product list during block 426 for a men's dress shoe, a customer may select information like: Material=Leather, Laces=No, Heel=1 inch, Color=Black, Tassels=Yes, Ankle height=Low. This type of information may be used to further filter the dress shoes displayed to the customer at block 426. Then upon the customer selecting a filtered dress shoe the corresponding product details page is displayed at block 412.

Returning to block 420 of FIG. 4, alternatively, when the customer selects a particular category, the customer may be presented suggested products at block 428. The suggested products presented to the customer at block 428 may include audio and/or video images accompanying the products displayed. Moreover, a professional opinion and/or review may be presented to the customer while the suggested product is displayed to the customer. Here, continuing the above example, because the customer selected men's business attire as the category then the smart fixture may present the customer suggested men's business outfits at block 428.

Furthermore, the suggested product may be more than one product. Here, the suggested men's business attire may be a model wearing a complete outfit including, a jacket, eyewear, shirt, pants, belt, watch, and/or shoes. The customer may zoom in or zoom out on any detail of the suggested product and/or rotate the image such that the product(s) may be viewed at any angle. The customer may select one or more of the suggested products.

At block 428, the customer may determine whether to obtain more information about the suggested product or products. Selection of the suggested product or products directs the customer to the product details page at block 412. Here, for example, the customer may select the men's dress shirt and shoes thereby the customer is directed to the corresponding product details page showing the men's dress shirt and/or shoes at block 412. The method continues through blocks 412-418 of which have been previously described above. However, if the customer does not select the suggested product then the method may be directed to sub-category page described above with respect to block 422. From block 422 the process may continue through blocks 422-426 and/or 412-418.

Returning to block 402 of FIG. 4, alternatively or subsequent to the customer initially touching the monitor 202 to stop the attract loop, the customer may instead scan a product's barcode at smart fixture 102 at block 430. As discussed above, scanning of the barcode may be a triggering event that causes the attract loop to stop. Subsequent to the scanned barcode the product's details page at block 412 is presented to the customer. Likewise, if a customer walks up to smart fixture 102 with an RFID tagged product, the smart fixture may present the product details page for that product to the customer. Thus, the customer can use readers 210 of smart fixture 102 to quickly access the product's details page.

FIG. 5 is a flowchart depicting a method 500 for the point of sale functionality of the smart fixture component shown in FIG. 2. Method 500 begins with block 502 where product identifying information is scanned and/or entered into smart fixture 102. For example, product identifying information may be obtained from a barcode and/or RFID tag scanned by reader 210 of the smart fixture 102. Furthermore, product identifying information may be obtained from an alphanumeric sequence on a previously printed product details page. Moreover, product identifying information can be obtained from search results and/or navigating the store's inventory and subsequently adding the product to the customer's shopping bag as described above in method 400 of FIG. 4.

Once the product has been identified, the customer may be presented a customer data entry interface at block 504 enabling the customer to purchase the product. For example, the customer data entry interface may ask the customer to swipe their credit card through the magnetic-strip reader and/or smart card reader. Moreover, the customer data entry interface may ask the customer to use an on-screen qwerty style keyboard to enter additional personal data to complete the transaction. For example, such personal data may include the customer's name, address, telephone number, store account number, loyalty reward card number, credit card number, and/or security code from their credit card.

At block 506, smart fixture 102 receives such personal data from the customer via the customer using, for example, the on-screen touch sensitive qwerty keyboard. As the customer is inputting their personal data, at block 508, smart fixture 102 may hide, or mask, the personal data from being displayed on monitor 202. In that regard, the personal data may be masked by asterisks, for example. Thus, other in-store customers may be prevented from viewing and/or obtaining the customer's personal data.

Optionally, a touch sensitive button may be displayed on monitor 202 that enables the customer to unhide their personal data as shown in block 510. The customer may want to unhide the personal information to review the data on monitory 202 for accuracy purposes.

Once the customer data entry interface receives all the required personal data, at decision block 512, smart fixture 102 asks the customer whether they are finished inputting their personal data. If the customer selects no then the method returns to block 506 waiting to receive personal data. For example, smart fixture 102 may recognize that the customer has entered enough personal data to complete the transaction. Thus, smart fixture 102 may asks the customer whether they are finished entering their personal data. However, for example, the customer may realize they entered inaccurate personal data and/or have yet to enter their loyal account card number for the retailer. In either case, the customer may want to return to block 506 by answering no. If the customer answers yes at decision block 512 then the method continues to block 514 where smart fixture 102 processes and accepts payment from the customer.

In some embodiments, smart fixture 102 includes a gift registry application. In that regard, having the gift registration application on smart fixture 102 greatly enhances both the registration process, as well as the gift purchasing experience. For example, gift registry may enable customers to purchase items of the registry for other people. Moreover, smart fixture 102 may enable the giver of the gift to record an audio and/or video message along with the gift. Furthermore, the receiver of the gift may additionally record an audio and/or video message before, during, and/or after the purchase of the gift to send to the giver via smart fixture 102. In fact, the audio and/or video messages may be sent to the receiver of the gift when the purchase is made and/or with the actual gift. Additionally, the audio and/or video messages sent from the gift receiver may be delivered to the giver before, during, and/or after the purchase has been made by the giver.

In some embodiments the application software running on smart fixture 102 is portable to mobile devices, such as remote device 114 in FIG. 1. For example, customers in a retail store can use a mobile device to enhance their shopping experience and have visibility into a greater number of products that are offered by the particular retailer at any of the retailer's store locations and on the retailer's online store. In this regard, the mobile device can include similar functionality as smart fixture 102, for example, touch screen, audio, browsing and searching capabilities, purchasing, and email options. Moreover, the valuable customer related data, as discussed above, can be tracked by the application and sent wirelessly to any device capable of connecting t network 106 including, for example, smart fixture 102 and server 108. In addition, the application for the mobile device can include reader functionality, thereby allowing customers to scan in products that they pick up throughout the store for further information.

Furthermore, the application for the mobile device may allow the customer to transmit their personal data to the smart fixture. For example, a customer may not prefer to physically type their personal data onto the monitor 202 because other customers passing by may determine their personal information. The application may allow the customer to transmit personal data to the fixture, for example, by the customer “shaking” their mobile device when prompted by smart fixture.

Moreover, the application may allow for the customer to create a shopping list of needed products on their mobile device. The shopping list may be transmitted wirelessly, for example, to smart fixture 102 where the corresponding products for sale by the retailer are identified and presented to the customer for purchase.

While the present invention has been illustrated by the above description of embodiments, and while the embodiments have been described in some detail, it is not the intention of the applicant to restrict or in any way limit the scope of the invention to such detail. Additional advantages and modifications will readily appear to those skilled in the art. Therefore, the invention in its broader aspects is not limited to the specific details, representative apparatus and methods, and illustrative examples shown and described. Accordingly, departures can be made from such details without departing from the spirit or scope of the applicant's general or inventive concept.

What is claimed is:

1. A system comprising:
a device comprising:
a monitor operable to display information to a customer;
a touch sensitive module coupled to the monitor;
an image capturing module operable to capture an image of the customer;
a local storage unit operable to store product information including information related to products in stock at a single location of a retail establishment, products in stock at other locations of the retail establishment, and products offered in an online store of the retail establishment;
an audio output operable to broadcast audio information including product information stored in the storage unit;
a reader operable to identify a product that is handled by the customer, the reader including at least one of a barcode scanner, an RFID scanner, a magnetic card reader, and a smart card reader;
a processing unit and a communications module communicatively coupling the device to a network, the processing unit running software that provides interactivity between the customer and the product information in the storage unit; and
a printing device operable to print product information; and
a server communicatively coupled to a database, the database storing product information, the server further communicatively coupled to the device via the network for sending up-to-date product information to the local storage unit of the device.

2. The system of claim 1, further comprising a remote device communicatively coupled to the device via the network, the device operable to provide product information to the remote device.

3. The system of claim 2, wherein the remote device is selected from the group consisting of a cell phone, notebook computer, netbook computer, desktop computer, tablet computing device, smart phone, personal digital assistance, and e-book reader.

4. The system of claim 1, further comprising a checkout device communicatively coupled to the device operable to allow the customer to purchase a product displayed by the monitor of the device at the checkout device, the checkout device positioned at one of the single location of the retail establishment and the other locations of the retail establishment.

5. The system of claim 1, wherein the reader enables the customer to purchase the product handled by the customer.

6. The system of claim 1, wherein the reader comprises the RFID scanner operable to read an RFID tag associated with a product to display product information associated with the product on the monitor.

7. The system of claim 1, wherein the reader comprises the barcode scanner operable to read a barcode associated with a product to display product information associated with the product on the monitor.

8. The system of claim 1, wherein the product information further includes information selected from a group consisting of description, image, color, sizing, style, availability, pricing, and location.

9. A device comprising:
a monitor operable to display information to a customer;
a touch sensitive module coupled to the monitor;
an image capturing module operable to capture an image of the customer;
a storage unit operable to store the image of the customer and product information including information related to products offered at a retail establishment and products offered in an online store of the retail establishment; and
a communication module communicatively coupling the device to a server via a network, the server accessing a database to provide up-to-date product information to the device.

10. The device of claim 9, wherein the captured image of the customer is used by the device to identify the customer.

11. The device of claim 10, wherein the device provides a personalized greeting to the customer identified by the device based on the captured image of the customer.

12. The device of claim 11, wherein the personalized greeting is unique to the customer.

13. The device of claim 9, wherein the captured image of the customer is used by the device to orient a customer with respect to the product information.

14. The device of claim 9, wherein the captured image of the customer is used by the device to provide the customer an augmented-reality.

15. The device of claim 14, wherein the augmented reality includes merging the captured image of the customer with an image of a product.

16. The device of claim 9, wherein the server accesses the database to provide up-to-date product information to the device when a change occurs to the product information stored in the database.

17. The device of claim 9, wherein touch sensitive module is operable to allow navigation of the device by the customer through touching the monitor.

18. The device of claim 9, wherein the product information includes an attract loop representing audio and visual data displayed as an initial sequence on the device until a triggering event occurs.

19. The device of claim 18, wherein the triggering event is one of touching the monitor, detecting motion adjacent the device, sensing audible noise near the device, detecting a temperature change, and detecting the customer through the captured image of the customer.

20. A method comprising:
providing a device at the retailer's store, the device comprising:
a monitor operable to display information to a customer,
a touch sensitive module coupled to the monitor,
an image capturing module operable to capture an image of the customer;
a reader operable to identify a product that is handled by the customer;
a storage unit operable to store the image of the customer and product information, the product information including information about products offered for sale in-store and online by a retailer, and
a communication module communicatively coupling the device to a network,
receiving updated data that includes changes to the product information and an attract loop, the attract loop attract loop representing audio and visual data related to the product information;
displaying the attract loop as an initial sequence displayed on the device, the attract loop being set by accessing the reader;
detecting a triggering event at the device that ceases the attract loop and allows the customer to navigate the device;
sending the captured image of the customer to a remote device connected to the network; and
communicating with a user of the remote device by accessing the captured image of the customer.

21. The method of claim 20, wherein accessing the reader to set the attract loop includes the reader reading a barcode corresponding to the stored attract loop to set the attract loop as the initial sequence displayed.

22. The method of claim 21, wherein communicating with the user of the remote device by accessing the captured image of the customer further comprises using the image to conduct a videoconference call between the customer and the user of the remote device.

23. The method of claim 20, wherein the remote user is unaffiliated with the retailer.

24. The method of claim 20, wherein communicating with the user of the remote device by accessing the captured image of the customer further comprises using the image to provide the customer an augmented-reality.

25. The method of claim 24, wherein the augmented-reality includes merging an image of a product with the captured image of the customer.

26. The method of claim 24, wherein using the captured image to provide the customer an augmented-reality is created by the user of the remote device.

27. The method of claim 24, wherein using the captured image to provide the customer an augmented-reality is created by the customer.

28. The method of claim 20, wherein the triggering event is one of touching the monitor, detecting motion adjacent the device, sensing audible noise near the device, detecting a temperature change, and detecting the customer through the captured image of the customer.

29. The method of claim 20, further comprising navigating the device by the customer touching the display in order to view product information.

30. The method of claim 20, further comprising accessing the display by the customer touching the display to enter personal data into the device in order to purchase a product, wherein the device masks the personal data being entered such the display shows the mask personal data.

31. The method of claim 30, accessing the display by the customer touching the display to direct the device to unmask the personal data.

32. The method of claim 20, further comprising navigating the device by the customer touching the display in order to view product information, wherein the product information includes alternate views of a product such that the customer.

33. The method of claim 32, wherein navigating the device by the customer touching the display includes the customer navigating the device to display at least two views of the product.

34. The method of claim 33, wherein the at least two views of the product are selected from the group consisting of a front view, side view, top view, bottom view, and 360° view.

35. The method of claim 33, wherein navigating the device to display the at least two views of the product includes one of zoom-in and zoom-out one of the at least two views of the product.
